(19) United States
(12) Patent Application Publication
(10) Pub. No.: US 2025/0356160 A1
(43) Pub. Date: Nov. 20, 2025

(54) System and Method for Creating Autonomous Digital Human Doubles

(71) Applicant: Mamoun Iraqi, Bouskoura (MA)

(72) Inventor: Mamoun Iraqi, Bouskoura (MA)

(21) Appl. No.: 19/170,915

(22) Filed: Apr. 4, 2025

Related U.S. Application Data
(60) Provisional application No. 63/647,973, filed on May 15, 2024.

(51) Int. Cl. G06N 3/004; G06N 3/0442; G06N 3/045; G06N 3/0464; G06N 3/092; H04L 9/06

(52) U.S. Cl. CPC G06N 3/004; G06N 3/0442; G06N 3/045; G06N 3/0464; G06N 3/092; G06Q 50/01; H04L 9/0631

(57) ABSTRACT

The present invention relates to a platform and system that uses advanced artificial intelligence (AI) and comprehensive multimodal data analysis to create dynamic, personalized digital doubles that authentically replicate an individual's personality, emotions, and behaviors. The system comprises multiple modules, including user registration, data collection, social network integration, chat, data analysis, personality and emotion simulation, digital double creation and improvement, banking and telecommunication services integration, user interaction and evaluation, progress tracking, security and privacy control, and a comprehensive algorithmic framework. The hierarchical memory structure with short-, mid-, and long-term layers manages data with promotion and purge mechanisms. A Parallel AI Supervisor checks and refines responses, while ethical and moral filtering mechanisms prevent outputs that violate moral norms. The Security and Privacy Control Center ensures data integrity, with potential blockchain-based logging of major changes, and an IA Watchdog detects suspicious modifications. The invention aims to enrich virtual interactions through dynamic, learning digital duplicates that offer deeply immersive and genuinely personal digital experiences.

The current application claims a priority to the U.S. Provisional Patent application Ser. No. 63/647,973 filed on May 15, 2024.

### FIELD OF THE INVENTION

The present invention relates generally to online social platforms and artificial intelligence for generating digital doubles of individuals. More specifically, the present invention is an integrated system and method for creating autonomous digital doubles of individuals on a web platform capable of learning, adapting their behavior, managing hierarchical memory, performing moral and ethical filtering, and ensuring robust security and privacy controls on a dedicated web platform.

### BACKGROUND OF THE INVENTION

With the advancement of digital technologies, there is a growing need to create more personal and meaningful interactions in virtual space. Current methods of communication and interaction fail to fully capture the complexity and richness of human expressions, thereby limiting the user experience. Current digital twin technologies or similar function primarily under predefined rules and human supervision. They typically function by following scripted responses and require manual updates and intervention to handle new or unforeseen situations. Existing models do not learn from interactions; they cannot adapt their responses based on past interactions or evolving data. They require continuous reliance on human input for decision-making and updates. This limits the scalability and effectiveness of the technology in dynamic environments. Most current technologies lack the ability to integrate and analyze data from multiple sources in real-time, resulting in responses that may not fully align with the context or the current needs of the user.

The present invention aims to overcome these limitations by providing an innovative system for creating and interacting with digital doubles of human beings, thereby enriching digital experiences with a personal and human touch. The present invention allows for autonomous learning, wherein the system gathers user data and applies advanced algorithms to model a user's behavior, style, and preferences. The double further comprises a hierarchical memory, allowing for short-, mid-, and long-term memory structures. A parallel AI supervisor checks the digital double's responses, corrects inconsistencies, and re-solicits user input if needed. Outputs that violet user or societal moral or ethical norms are prevented, and privacy and data integrity is ensured through blockchain-based logging of major changes and an IA watchdog for detecting suspicious modifications.

### SUMMARY OF THE INVENTION

The present invention relates to an integrated system and method for creating and managing digital doubles of individuals on a dedicated web platform. This platform collects various forms of data (videos, photos, voices, texts, etc.) provided by users and uses advanced algorithms to analyze and process this data. The data is further stored in a hierarchical memory with explicit thresholds for promotion or purging. The double's real-time outputs are controlled via a parallel AI supervisor that corrects or refines behavior, as well as a moral filtering mechanism. An IA watchdog logs major state changes and can roll back tampered data to a previous valid snapshot. The goal is to generate a digital double that faithfully imitates the user's appearance, voice, behaviors, and preferences, thus offering a new dimension to digital social interaction.

### BRIEF DESCRIPTION OF THE DRAWINGS

FIG. 1 is a flowchart showing the steps and algorithms of the present invention.

FIG. 2 shows an example of a user registration and verification page for the platform of the present invention.

FIG. 3 shows an example of a menu screen and audio tab for the platform of the present invention.

FIG. 4 shows an example of a screen showing the audio assets for the platform of the present invention.

FIG. 5 shows an example of an audio recording screen for the platform of the present invention.

FIG. 6 shows an example of a photo analysis and video generation screen for the platform of the present invention.

FIG. 7 shows an example of a video gallery and creation screen for the platform of the present invention.

FIG. 8 shows an example of a feedback survey for a user of the platform of the present invention.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a system and method for creating autonomous digital human doubles, embodiments of the present disclosure are not limited to use only in this context.

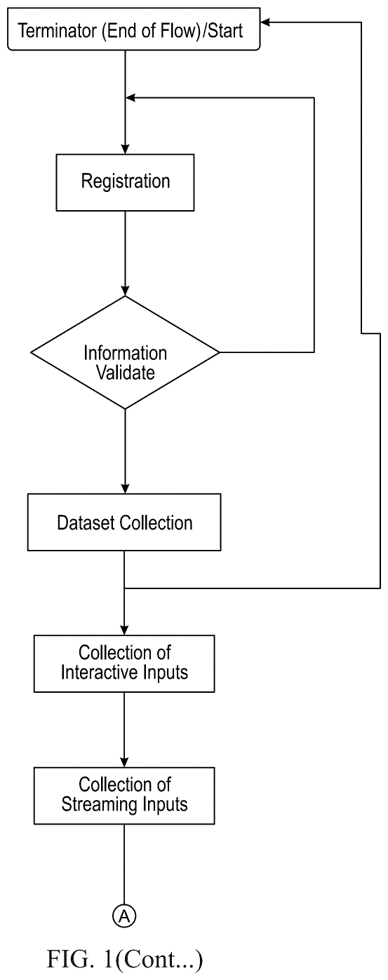

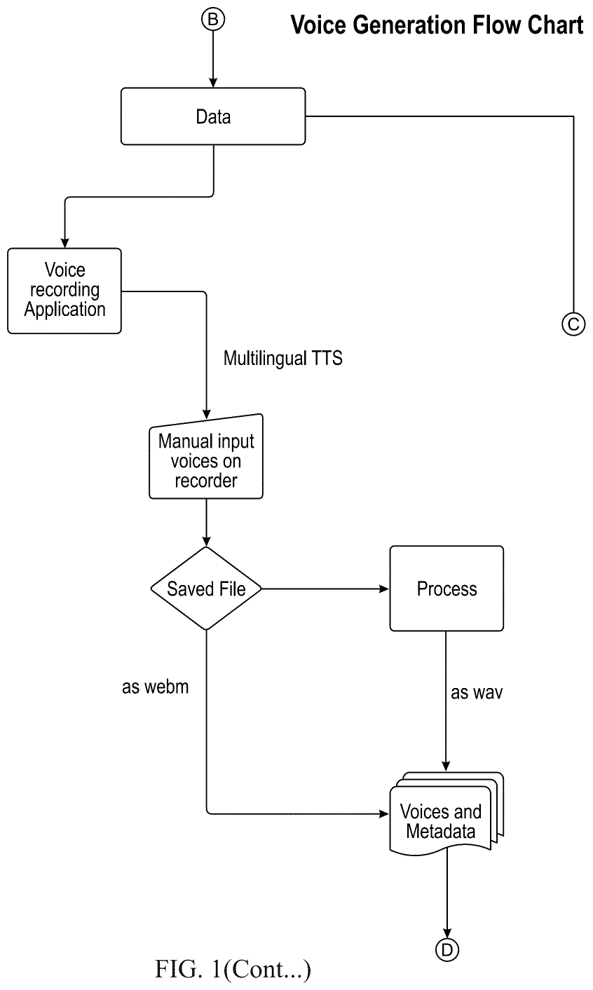

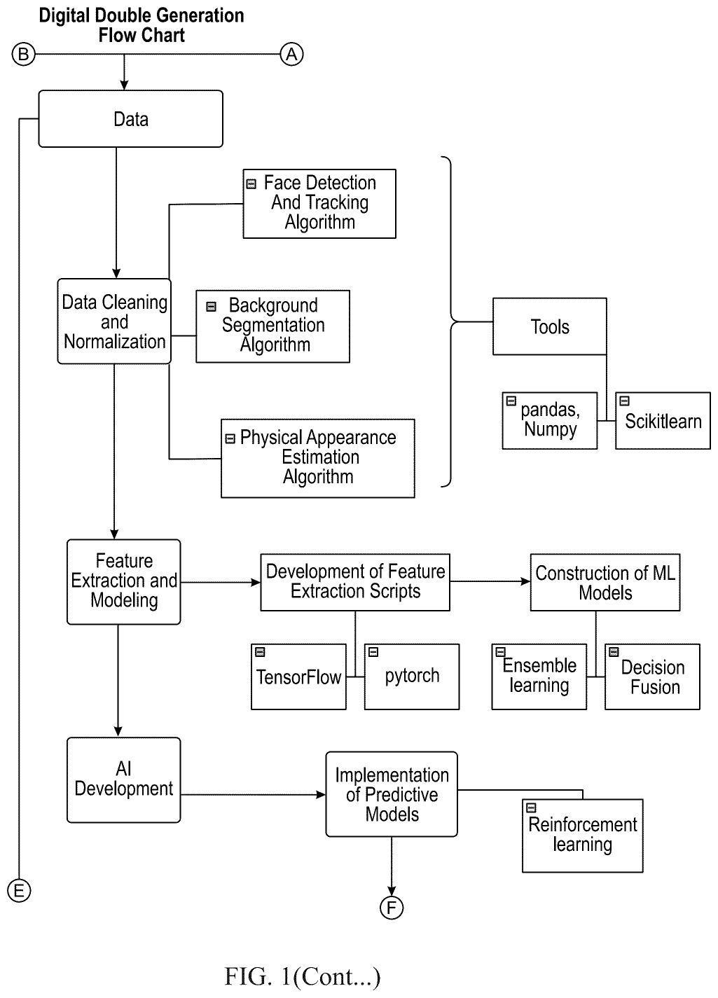

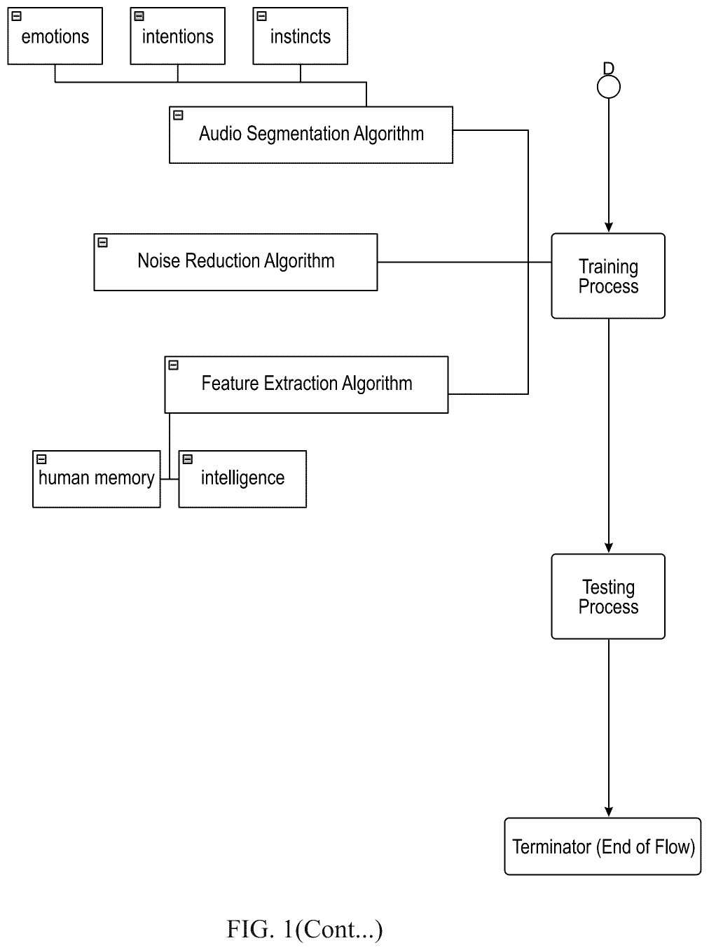

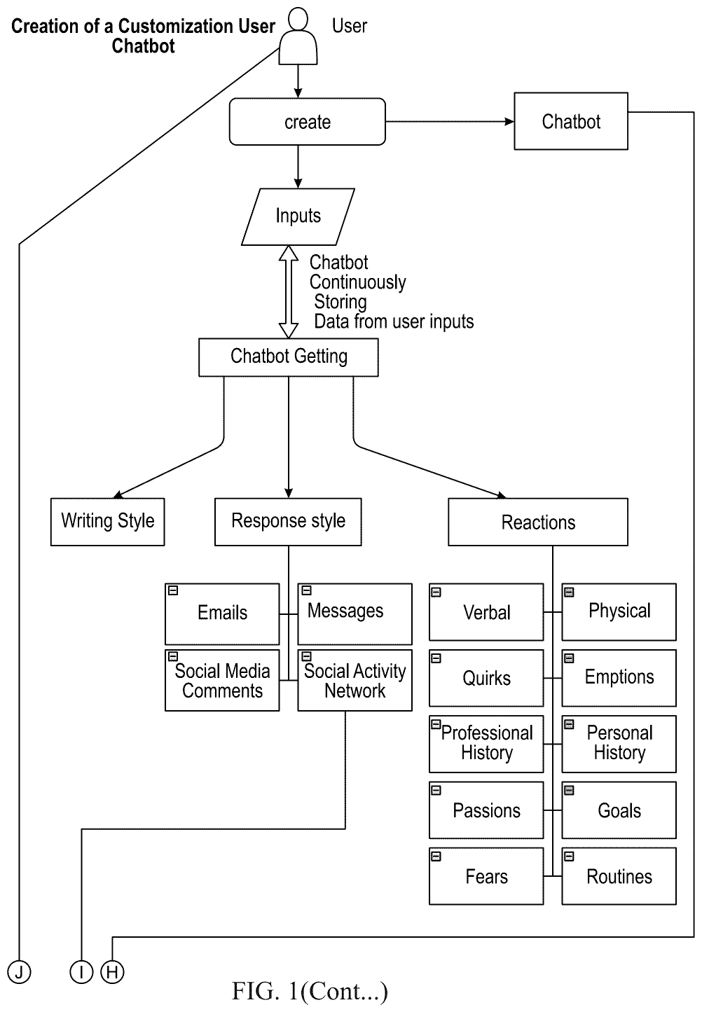

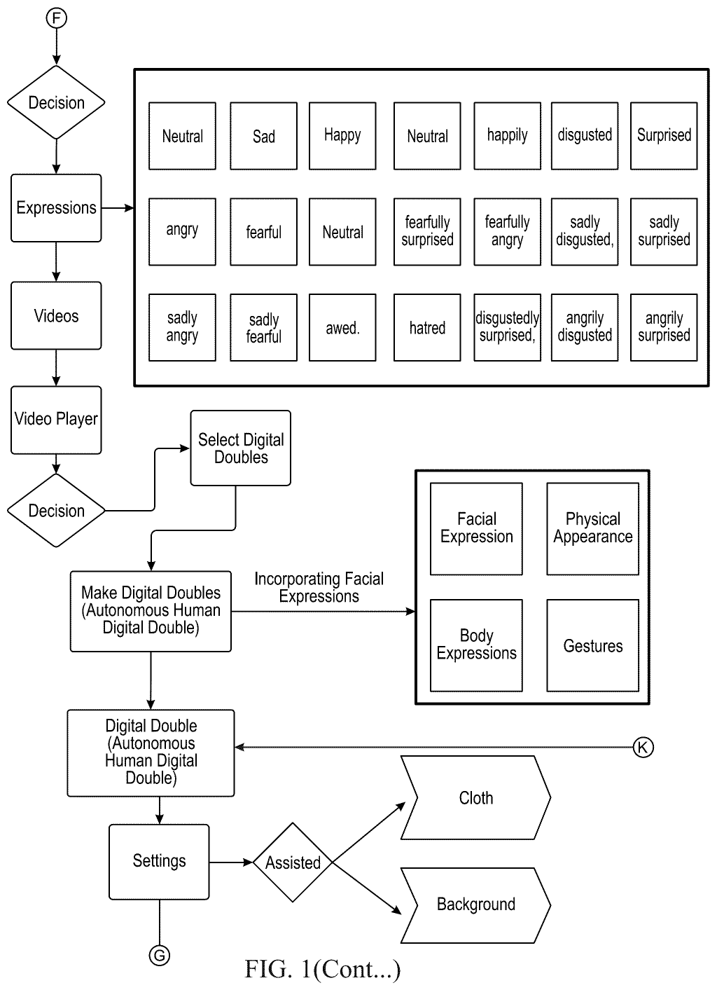

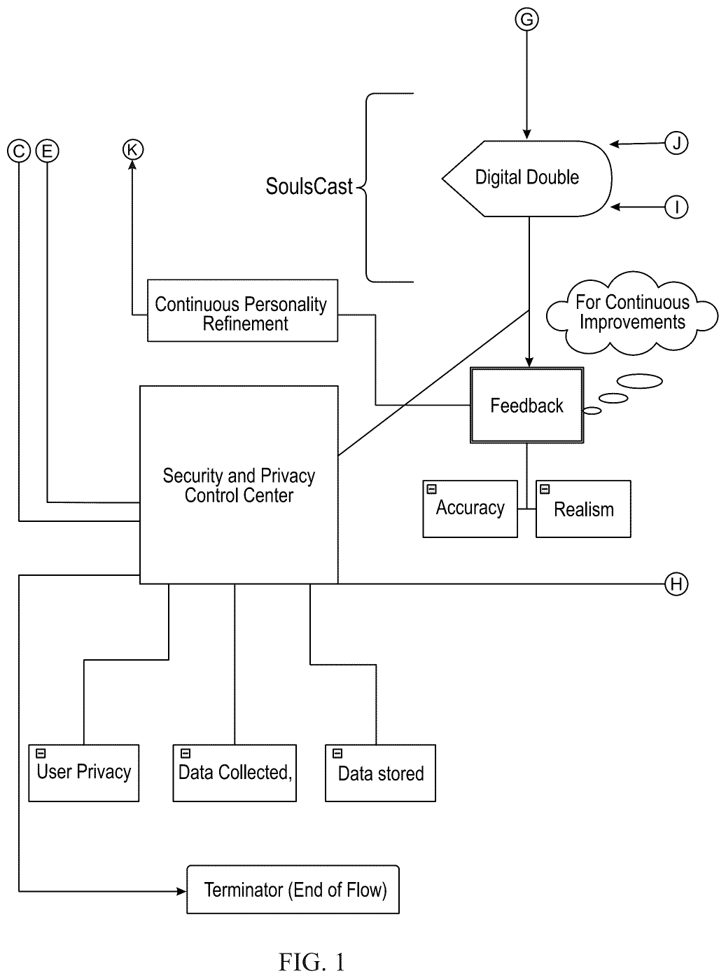

The present invention is a platform and system that uses advanced artificial intelligence (AI) and comprehensive multimodal data analysis to create dynamic, personalized digital doubles that authentically replicate an individual's personality, emotions, and behaviors, offering a deeply immersive and genuinely personal digital interaction experience. The digital doubles of the present application may also be referred to as doubles, avatars, or any similar word. These words as used in the figures are interchangeable. The present invention comprises a plurality of modules, including but not limited to: a user registration module, data collection interface, social network integration module, chat module, data analysis and processing system, personality and emotion simulation engine, digital double creation and improvement mechanism, banking and telecommunication services integration, user interaction and evaluation platform, progress tracking and reporting dashboard, security and privacy control center, and a comprehensive algorithmic framework. The flowchart of FIG. 1 features blocks labeled “Terminator (End of Flow)”. This symbolizes a final step and is a flowchart convention, not a separate feature.

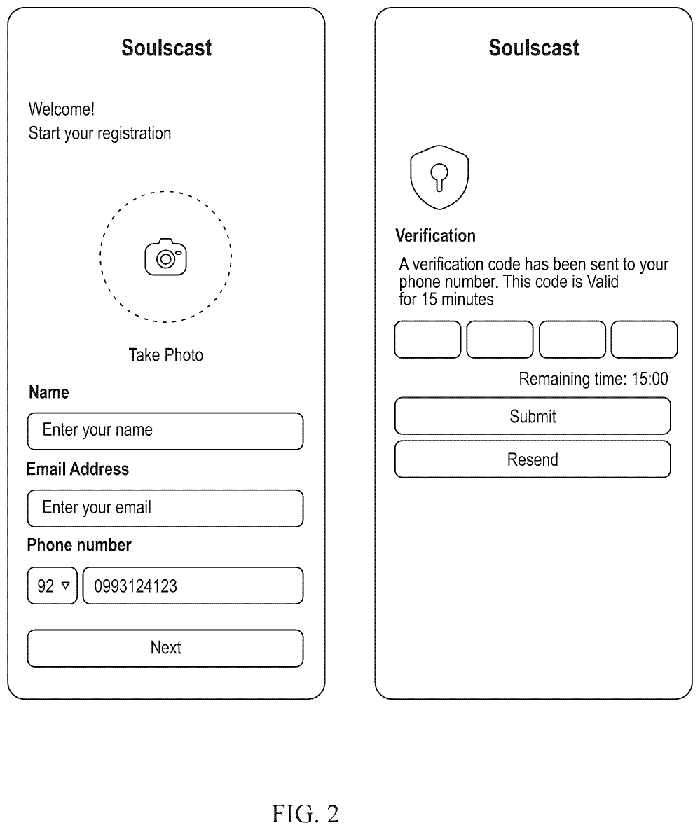

The user registration module is the entry point for users, where they verify their identity and set up their profiles, as shown in FIG. 2. It ensures that each digital double created on the platform has a corresponding real individual, establishing the foundation for personalization. The data collection interface allows users to upload various forms of data, including text, voice, photos, videos, and locations. Data may also be imported from social media. This data serves as the raw material for building and continuously updating the digital double.

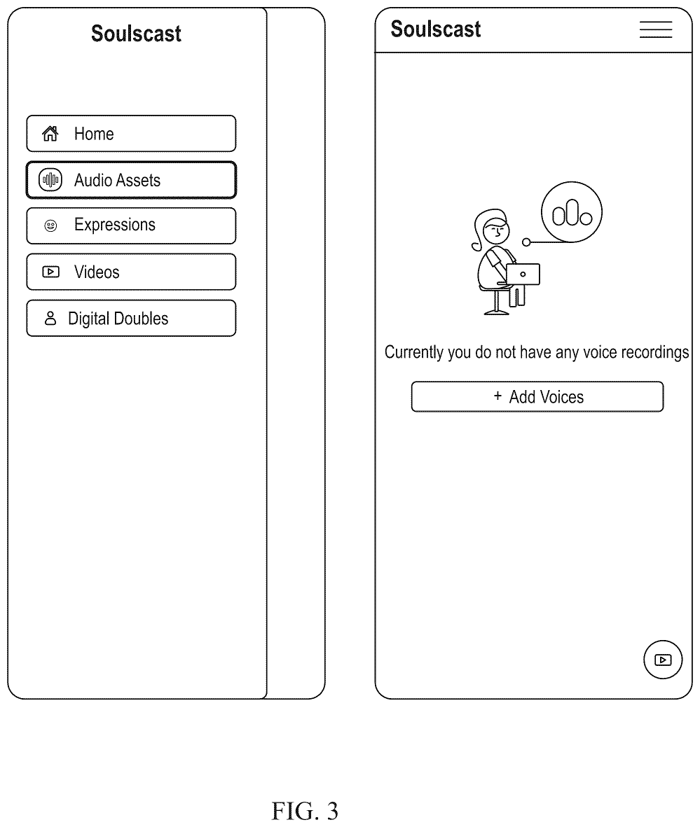

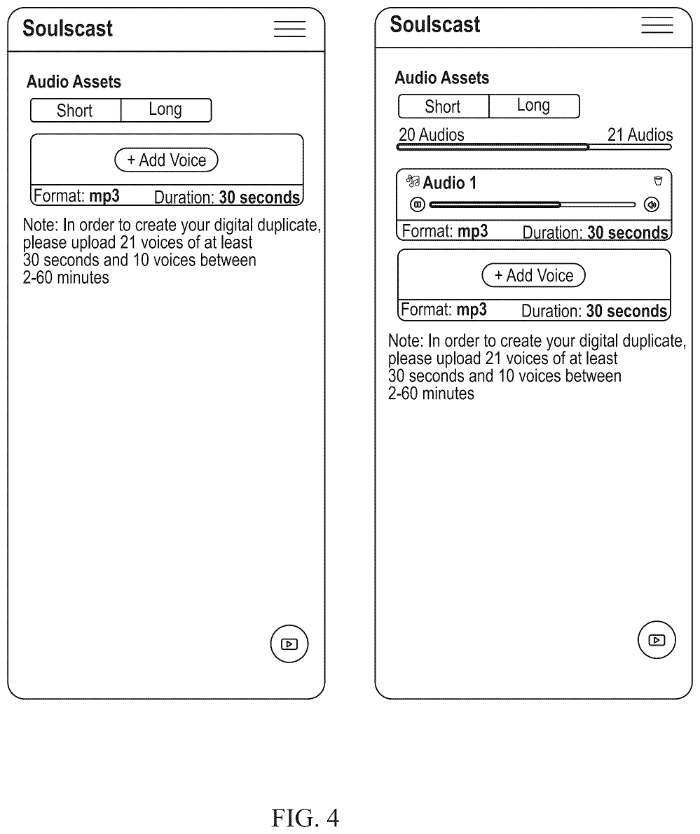

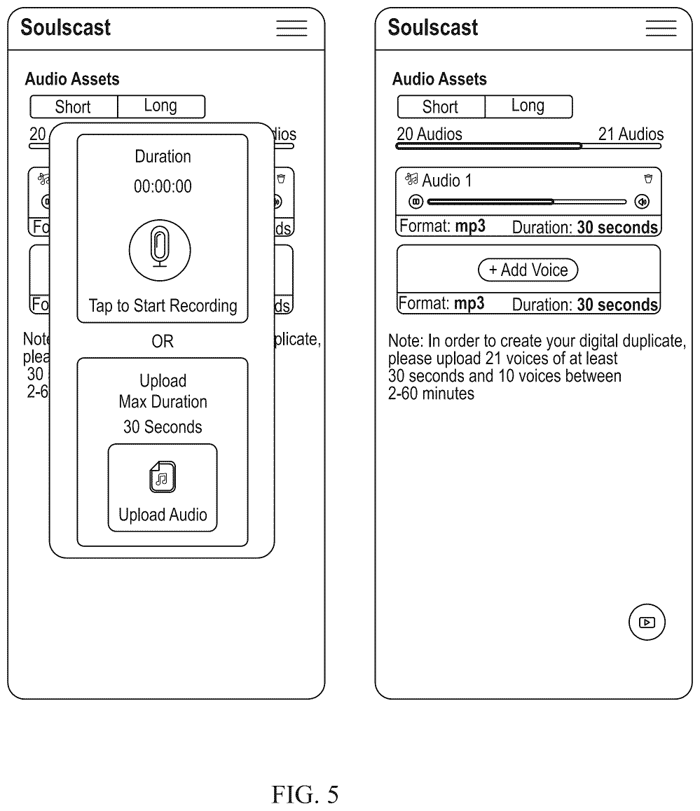

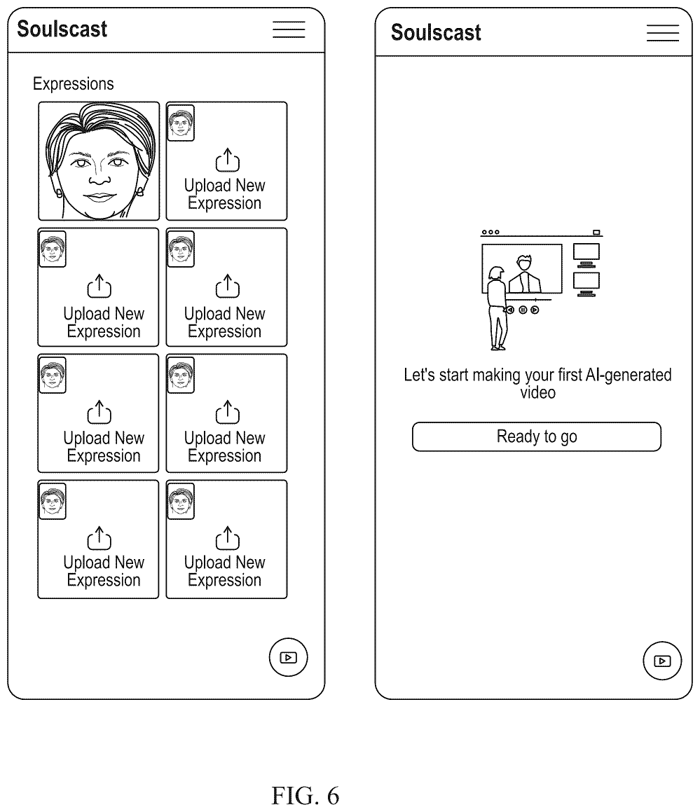

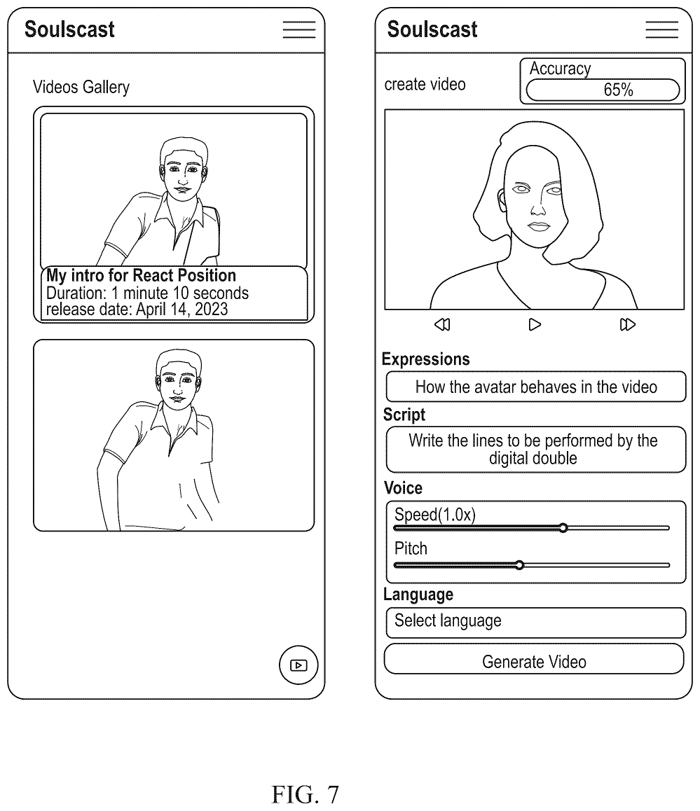

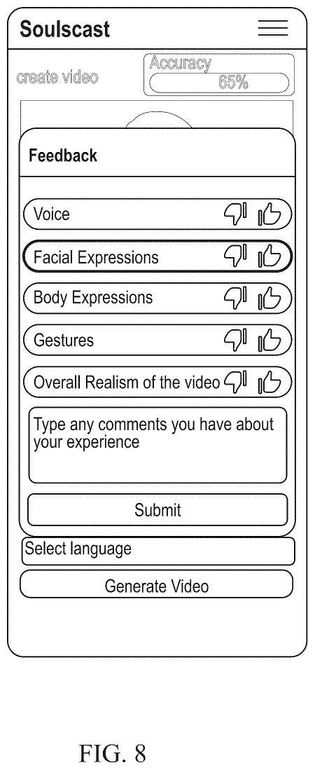

FIG. 3 shows example screens of the app, wherein the user may access various features. FIG. 3 further shows the screen where the user may add a voice recording. FIG. 4 shows the audio assets module, wherein the user may add audio assets and listen to existing assets. FIG. 5 shows a recording screen wherein the user may record or upload audio assets. The durations and requirements for audio assets shown in the figures are examples and are not intended to be limiting. The present invention may require any amount of short or long audio files, and the duration requirements for the audio files may vary. FIG. 6 shows a module wherein the user may view and upload photos to be used as references for the double's facial expressions. The flowchart of FIG. 1 shows a selection of possible expressions, but this is not intended to be limiting. FIG. 7 shows a video module wherein the user may upload videos to be used as references for gestures and expressions. The accuracy shown in FIG. 7 represents how closely the digital double's generated output matches the user's real data. 65% is an example for illustrative purposes, meaning that the double matches the user's real data fairly well but can be improved. The user may input expressions and behaviors for the digital double and words and phrases for the double to perform. The user may also adjust the speed of the double's speech, the pitch, and the language spoken. FIG. 8 shows a feedback survey, wherein the user may rate various aspects of the double and provide feedback.

The social network integration model allows users to connect existing social network accounts to the platform to easily import data as well as invite contacts to join the platform. The chat module enables real-time communication between users, digital doubles, and their connections. Said communication may take the form of text, voice, or video chats Data from these interactions may also be used to refine the digital doubles' responses and behaviors. The digital double continuously evolve to post, comment, like, and otherwise engage autonomously in a social media environment.

The data analysis and processing system processes the data collected in the other modules. It uses algorithms for text, voice, image, and behavioral analysis to extract personality traits, emotional patterns, and preferences to inform and refine the digital double. Said algorithms may include Recurrent Neural Networks (RNNs) for sequential data processing and Convolutional Neural Networks (CNNs) for analyzing visual information, enabling the digital double to learn, adapt, and make decisions autonomously. The personality and emotion simulation engine utilizes the insights gained from the data analysis and processing system to model the digital double's personality traits and emotional responses. This engine ensures that the digital double authentically represents its human counterpart. The digital double learns from every interaction, using reinforcement learning to refine its algorithms and improve its interactions based on real-time data. The multimodal and real-time learning approach allows for more personalization.

The digital double creation and improvement mechanism generates and continuously updates the digital double as data is collected. This module also incorporates user feedback to further refine the digital double. The banking and telecommunication services module offers advanced functionality for the digital double, including the ability to manage a digital bank account and communicate via an IP-based telephone service.

The user interaction and evaluation platform allows users and their network to interact with the digital double and provide feedback on its accuracy and realism. This feedback is crucial for the continuous improvement mechanism, ensuring the digital double evolves in alignment with the user's expectations. The progress tracking and reporting dashboard offers users a visual representation of their digital double's development progress, based on the data analysis and improvement feedback. It guides users on what additional information might enhance their double's accuracy.

The present invention may further comprise an AI Assistant module. The AI assistant aids content creation, generates media, and provides real-time insights. The user may review and approve any generated media.

The security and privacy control center ensures all data collected, stored, and processed through the platform is securely managed, protecting user privacy and maintaining trust. This center supports all components by enforcing data access controls and encryption. Security measures may include AES-256 encryption and multi-region replication and are fully compliant with GDPR and HIPAA. The comprehensive algorithmic framework integrates AI, NLP, computer vision, and machine learning (ML) techniques to dynamically model personality, character, and reactions. The comprehensive algorithmic framework synthesizes the inputs and analyses from the other modules to generate a responsive and evolving digital double.

The present invention is capable of functioning independently without human intervention. FIG. 1 is a flowchart showing the various steps and algorithms used in the present invention to create the digital double.

A data cleaning and normalization algorithm is responsible for preparing the raw data for further analysis and modeling. This algorithm handles missing values, removes outliers, and scales features to ensure uniformity and consistency across the dataset. The tools used may include Python, Pandas, NumPY, scikit-learn, NLTK, spaCy, Matplotlib, Seaborn, and other libraries which are employed to implement various preprocessing techniques.

A feature extraction and modeling algorithm captures relevant information from the data to facilitate effective modeling. This algorithm develops scripts using advanced deep learning frameworks such as TensorFlow and PyTorch to extract discriminative features from diverse data types, including images, text, and sequential data.

A construction of ML model algorithm builds ML models tailored to specific data types and tasks. CNNs analyze visual information, and RNNs process sequential data. Other models may also be used and are within the scope of the present invention, including decision trees, support vector machines, and ensemble methods.

The present invention further comprises a user chatbot, which utilizes algorithms for text, video, photo, and audio data. Libraries such as Natural Language Toolkit (NLTK) can scrape and extract data from emails and messages, with user consent. Social media Application Programming Interfaces (APIs) may gather data from public or private social media posts, with appropriate user authorization. The present invention may also collect data from surveys and questionnaires targeted to collect specific information about the user's communication style, preferences, or background. Said surveys and questionnaires may employ further algorithms to identify the objective of the survey (e.g. personality traits, preferences, or behaviors), collect, store, analyze, and process data, and extract features. Text data may be preprocessed by removing punctuation and special characters, standardizing text, addressing typos and grammatical errors, and scaling or normalizing the data to ensure all features contribute equally during model training.

Video data may be acquired from sources including lectures, presentations, and webcam recordings. These recordings analyze body language, teaching styles, day-to-day interaction patterns, gestures, and other details. Tools such as OpenCV offer real-time video processing to track movements, expressions, and interactions, and FFmpeg may be employed for video format conversions and stream processing. Frame extraction and motion analysis algorithms further analyze the dynamics of movements and interactions captured from video data.

Photo data may be acquired from social media, with the user's permission, or from photos uploaded by the user. Tools such as Adobe Photoshop and Google Vision APIs may be used to edit, analyze, and extract data from the photo data. Images may be automatically tagged with metadata including date, location, and identified objects or people.

Audio data may be acquired from captured voice communications, environmental sounds, and audio directly uploaded by the user, such as an MP3 file. Tools such as Audacity or Adobe Audition maybe be used for detailed audio editing and processing, and libraries such as Librosa may analyze audio and music to extract features including tempo, beat, and harmonic elements. Voice recordings may also be converted into text using text-to-speech.

The present invention further comprises hierarchical memory and thresholds.

### Layers

Short-term memory (STM): ephemeral data up to N user interactions or a certain timeframe. Items beyond N or older than T_{STM} are demoted unless labeled “keep”.

Mid-term memory (MTM): items surpassing a usage frequency fᵤ or emotional weighting ω≥0.5 within T_{MTM} days.

Long-term memory (LTM): data used>X times over Y days or flagged “critical”. Contradictory data triggers merges, forced updates, or retirement of older info.

### Promotion and Purge

Promotion conditions algorithm: Promote (item)=True if (frequency≥fᵤ)∨(emotional_weight≥ω)∨(userOverrride=True).

Purge Condition: if an item in MTM is unused for D consecutive days or overshadowed by contradictory data, the item reverts to STM or is purged.

### Parallel AI Supervisor and Moral Filtering

### Parallel AI Supervisor

Coherence Score: Each prospective output O is given a coherence score C(O). If C(O)<Θ, the system blocks or re-solicits user data.
Gap Detection: If the user has insufficient examples in anger/stress contexts, the supervisor requests more data.

### Moral Filtering

Classifier: A pipeline checks text or audio for potential moral or ethical violations, referencing user defined severity levels.
Light Mode: Provide synonyms or re-check instructions.
Strict Mode: Hard block.
Self-Regulation: If repeated blocks occur, the Double's language model (transformer or RNN) lowers the probability of generating similar offending patterns.

The present invention provides an autonomous digital double which may serve a variety of functions. The doubles are capable of complex human-like interactions without the need for ongoing human oversight.

### Security, IA Watchdog, and Optional Blockchain

### Security & Privacy Control Center

As in the Provisional Patent, encryption (e.g., AES-256) ensures user data confidentiality.
Compliance with relevant standards (GDPR, HIPAA) is managed by logs, user consents, data access controls.

### IA Watchdog

Maintains hashed references of the Double's key memory states (like major promotions to LTM).
If a future check reveals a mismatch (≥δ in state parameters or hash discrepancy), it triggers a rollback to the last verified snapshot.

### Blockchain (Optional)

The system can optionally record the hashed logs onto a distributed ledger for immutable tracking.

Although the invention has been explained in relation to its preferred embodiment, it is to be understood that many other possible modifications and variations can be made without departing from the spirit and scope of the invention.

1. A platform and system for creating dynamic, personalized digital doubles, comprising:
a user registration module for identity verification and profile setup;
a data collection interface for uploading various forms of data, including text, voice, photos, videos, and locations;
a social network integration module for importing data from social media and inviting contacts;
a chat module for real-time communication between users, digital doubles, and their connections;
a data analysis and processing system using algorithms for text, voice, image, and behavioral analysis;
a personality and emotion simulation engine for modeling personality traits and emotional responses;
a digital double creation and improvement mechanism for generating and updating the digital double;
a banking and telecommunication services integration module for managing digital bank accounts and IP-based telephone services;
user interaction and evaluation platform for feedback on the digital double's accuracy and realism;
a progress tracking and reporting dashboard for visual representation of the digital double's development;
a security and privacy control center for managing data access controls and encryption; and
a comprehensive algorithmic framework integrating AI, NLP, computer vision, and machine learning techniques.

2. The platform and system of claim 1, wherein the data analysis and processing system comprises;
recurrent Neural Networks for sequential data processing;
convolutional Neural Networks (CNNs) for analyzing visual information; and
algorithms for reinforcement learning to refine interactions based on real-time data.

3. The platform and system of claim 1, wherein the security and privacy control center employs AES-256 encryption for data confidentiality and compliance with GDPR and HIPAA standards.

4. The platform and system of claim 1, further comprising:
a hierarchical memory system with short-term, mid-term, and long-term memory layers; and
promotion and purge algorithms for managing memory items based on usage frequency and emotional weighting.

5. The platform and system of claim 1, further comprising:
a parallel AI supervisor for coherence scoring and gap detection; and
a moral filtering classifier for checking text or audio for potential moral or ethical violations.

6. The platform and system of claim 1, wherein the system can optionally record hashed logs onto a distributed ledger for immutable tracking.

7. A system for creating and managing autonomous digital human doubles on a web platform, the system comprising;
a hierarchical memory architecture with short-, mid-, and long-term layers, each governed by a dynamic promotion/purge algorithm dependent on usage frequency, emotional weighting, or user/AI overrides;
a parallel AI supervisor configured to;
calculate a coherence score for each prospective output relative to a user-defined personality model,
re-solicit user data if said score is below a threshold, and
block or correct outputs that deviate from the user's style or preferences;
a moral filtering module that examines outputs for ethical compliance under user-chosen severity modes, preventing publication of flagged content or offering reformulation suggestions;
a security and privacy control center that logs critical memory changes in hashed form, optionally storing them on a blockchain; and
an IA Watchdog that monitors for tampering and reverts the system to a previously validated state upon detecting suspicious anomalies.

8. The system of claim 7, wherein the promotion algorithm uses a threshold function: Promotion (item)=True, if usage frequency≥threshold, True, if emotional weight≥threshold, True, if userOverride=True, False, otherwise;
and said item is automatically purged if it remains unaccessed in mid-term memory for a certain number of consecutive days or overshadowed by contradictory user data.

9. The system of claim 7, wherein the moral filtering module employs at least two severity modes, said modes comprising;
light mode, which provides=es alternative synonyms or re-checks instructions for flagged phrases; and
strict mode, which directly blocks any flagged output until user or parallel AI override is applied.

10. The system of claim 7, wherein the IA Watchdog maintains a reference of hashed states for each memory promotion or user-labeled “critical” data point, comparing the current memory structure's hash to the reference. Upon a mismatch≥threshold, the system reverts the memory or personality states to a last-known valid snapshot, ensuring the double's authenticity.

11. A method for adaptively learning and securing an autonomous digital human double, comprising the steps of;
collecting user data (images, voice, text, video) and storing them in short-term memory, demoting older items or duplicates if not flagged “keep”;
promoting items to mid-term memory upon meeting a usage frequency threshold or emotional weighting, and further promoting them to long-term memory once validated via repeated user or AI supervisor confirmation;
filtering proposed outputs through a moral classifier, wherein flagged items are either blocked, re-checked, or replaced with synonyms depending on the user's chosen severity level;
computing a coherence score to compare each output to a user-defined style, automatically refining the double's short-term parameters if the score is below a threshold; and
securing all major memory or personality changes by creating hashed records in a secure data store, wherein the IA Watchdog can trigger a rollback upon detection of a mismatch between current states and those hashed records.

12. The method of claim 11, further comprising coherence gap detection, wherein the parallel AI supervisor periodically checks memory usage patterns to identify underrepresented emotional contexts or personality aspects, prompting the user to supply additional data or examples.
